(19) United States
(12) Patent Application Publication
(10) Pub. No.: US 2010/0151357 A1
(43) Pub. Date: Jun. 17, 2010

(54) METALLIC SEPARATOR FOR FUEL CELL

(75) Inventors: Kyoo Young Kim, Pohang (KR); Sung Ung Koh, Pohang (KR); Kwang Min Kim, Pohang (KR)

Correspondence Address: OCCHIUTI ROHLICEK & TSAO, LLP, 10 FAWCETT STREET, CAMBRIDGE, MA, 02138, US

(73) Assignee: Postech Academy-Industry Foundation, Pohang (KR)

(21) Appl. No.: 12/066,316

(22) PCT Filed: Jul. 18, 2007
(86) PCT No.: PCT/KR07/03474

§ 371 Date: Mar. 10, 2008

(30) Foreign Application Priority Data
Dec. 13, 2006 (KR) 10-2006-0126883

(51) Int. Cl. H01M 8/02

(52) U.S. Cl. 429/514

(57) ABSTRACT

A metallic separator for a fuel cell with high corrosion resistance and low contact resistance without surface coating is provided. The separator for a fuel cell is formed by adding one or more of tantalum (Ta) and lanthanum (La) to an austenitic stainless steel that contains molybdenum (Mo) and tungsten (W).

### TECHNICAL FIELD

The present invention relates to a separator for a fuel cell, and more particularly, to a metallic separator for a fuel cell with high workability, a low cost, high corrosion resistance, and low contact resistance in comparison with a conventional graphite separator.

### BACKGROUND ART

In general, fuel cells are electric generators which generate electric energy from hydrogen or the like. The fuel cells are classified into phosphoric acid fuel cells (PAFCs), molten carbonate fuel cells (MCFCs), solid oxide fuel cells (SOFCs), polymer electrolyte membrane fuel cells (PEMFCs), and the like. Operating temperatures of the fuel cells are varied according to the types of the fuel cells. The SOFC have an operating temperature of about 1,000° C. The MCFCs have an operating temperature of about 650° C. The PAFCs have an operating temperature of about 200° C. The PEMFCs have an operating temperature of about 100° C. or less.

Since the fuel cell generates heat as well as electricity in an electrochemical reaction, high electricity generation efficiency, such as a total efficiency of 80% or more can be obtained. Since the efficiency of the fuel cell is higher than that of conventional thermal power generation, it is possible to reduce an amount of the fuel for generating electricity. In addition, the fuel cells having various capacities can be implemented by laminating unit cells. In addition, various types of fuel such as hydrogen, a coal gas, a natural gas, a landfill gas, methanol, or gasoline can be used. In addition, reaction products of the fuel cell are not pollutants, and noise is also very small. Accordingly, the fuel cell can be manufactured by using an environment-friendly pollution-free energy technique. In addition, the fuel cell can be applied to a small scale generating system as well as a large scale generating system.

In the PEMFC, a polymer membrane having hydrogen ion exchange characteristics is used as an electrolyte. The operating temperature of the PEMFC is lower than those of other fuel cells. The efficiency of the PEMFC is higher than those of other fuel cells. In addition, the PEMFC has large current density, large output density, a simple structure, a speedy start-up response characteristic, and a good durability. In addition, the PEMFC can use methanol or a natural gas instead of hydrogen. Therefore, the PEMFC can be used as a power source for automobile or home.

The PEMFC mainly includes a polymer electrolyte membrane, electrodes, and a bipolar plate constituting a stack. In the PEMFC, the bipolar plate prevents reactants, that is, hydrogen and oxygen gases from being mixed with each other. In addition, the bipolar plate electrically connects a membrane electrode assembly (MEA) and supports the MEA to maintain a shape of the fuel cell. Accordingly, the bipolar plate needs to have a dense structure so that hydrogen and oxygen gases cannot be mixed with each other. The bipolar plate needs to have high conductivity so as to be used as a conductor. The bipolar plate needs to have sufficient mechanical strength so as to be used as a supporter. Since the cost of the bipolar plate occupies a considerable portion of the total cost of the PEMFC, it is preferable to develop an inexpensive bipolar plate suitable for the operating environment of the fuel cell.

Most of the bipolar plates have been constructed by using graphite having high conductivity and high chemical stability. And the bipolar plate is generally manufactured through a machining process. Although the graphite has high conductivity and high chemical stability to a highly-acidic electrolyte solution, the graphite has low tensile strength and low ductility, so that the graphite has a poor workability. Accordingly, it is difficult to manufacture the bipolar plate by using the graphite. In addition, since the bipolar plate has a considerable thickness of a predetermined value or more, volume and weight of the fuel cell also increase. Accordingly, efficiency and power per unit weight or unit volume is decreased. Furthermore, since a production cost of the PEMFC is very high, the PEMFC has a limitation to commercialization thereof.

In order to overcome the disadvantage of graphite, a technique of using a metal instead of the conventional graphite has been attempted. A metal has enough mechanical strength and workability to be used as the bipolar plate. In addition, the bipolar plate can be manufactured with the metal at a low material cost and a production cost. In addition, since the thickness of the bipolar plate can be reduced by using the metal, it is possible to increase the efficiency and power per unit volume or unit weight.

However, in a case where the bipolar plate is manufactured by using the metal, corrosion occurs in the highly-acidic electrolyte solution, so that the electrode and the electrolyte may be contaminated. Due to the by-product of corrosion on the surface of the bipolar plate, the conductivity is lowered, and metal ions penetrate into the polymer electrolyte membrane, so that mobility of hydrogen ions is decreased. As a result, the efficiency of the PEMFC is decreased.

In order to solve the problem of corrosion, there has been proposed a method of corrosion resistant coating on a surface of the metal bipolar plate. In this method, layers formed by the coating process deteriorate the chemical stability of the bipolar plate. Accordingly, the bipolar plate is vulnerable to the corrosion. In addition, due to the coating process, the production cost is increased.

Recently, as a substitute for the graphite, an austenitic stainless steel having a relatively high corrosion resistance to the highly-acidic electrolyte solution has been widely researched and developed. However, since the austenitic stainless steel has relatively high contact resistance, the efficiency of the PEMFC is decreased.

Accordingly, in order to facilitate commercialization of the PEMFC, a material of the metal bipolar plate having high corrosion resistance, high contact resistance, and high workability has been demanded.

### DISCLOSURE

### Technical Problem

The present invention provides a metallic separator for a fuel cell having high corrosion resistance and low contact resistance without surface coating.

### Technical Solution

According to an aspect of the present invention, there is provided a separator for a fuel cell, formed by adding one or more of tantalum (Ta) and lanthanum (La) to an austenitic stainless steel that contains molybdenum (Mo) and tungsten (W).

In the aspect of the present invention, since the tantalum (Ta) and the lanthanum (La) are added to the stainless steel having high mechanical strength, high workability, a low material cost, and a low production cost and capable of reducing thickness and improving efficiency and power per unit volume or unit weight as compared with graphite material, so that it is possible to improve corrosion resistance and greatly reduce contact resistance.

In the above aspect, preferably, an amount of the tantalum (Ta) and an amount of the amount of the lanthanum (La) may be in a range of 0.01 wt % to 1.0 wt %. If the amount of the tantalum (Ta) and the amount the lanthanum (La) are less than 0.01 wt %, it is difficult to improve the corrosion resistance and the contact resistance. If the amount of the tantalum (Ta) and the amount the lanthanum (La) are more than 1.0 wt %, homogeneity of the material deteriorates, so that the corrosion resistance is deteriorated.

In addition, more preferably, the amount of the tantalum (Ta) and the amount the lanthanum (La) may be in a range of 0.2 wt % to 0.7 wt %.

In addition, preferably, the amount of the molybdenum (Mo) may be in a range of 0.2 wt % to 5 wt %, and the amount of the tungsten (W) may be in a range of 0.01 wt % to 15 wt %.

### ADVANTAGEOUS EFFECTS

According to the present invention, it is possible to improve efficiency and power per unit volume or unit weight by using a separator for a fuel cell which is manufactured by using an austenitic stainless steel having high mechanical strength, high workability, a low material cost, and a low production cost and capable of reducing a thickness thereof. In addition, it is possible to improve corrosion resistance and to reduce contact resistance by adding tantalum (Ta) and/or lanthanum (La) as compared with a conventional metallic separator made of a stainless steel.

### BEST MODE

Hereinafter, embodiments of the present invention will be described in detail. However, the embodiments are exemplary ones, but the present invention is not limited thereto.

A stainless steel is produced by controlling an amount of tantalum (Ta) and an amount of lanthanum (La) in compositions shown in Table 1.

More specifically, Samples Nos. 1 to 8 are obtained by adding tantalum

(Ta) and/or lanthanum (La) to the stainless steel. Samples Nos. 9 to 11 are obtained without addition of tantalum (Ta) or lanthanum (La) to the stainless steel.

TABLE 1
Compositions of Embodiments of the
Present invention and Comparative Examples

| | Composition (wt %) | | | | | | |
|---|---|---|---|---|---|---|---|
| Sample No. | Cr | Ni | Mo | W | Ta | La | Fe |
| 1 | 18 | 12 | 2 | 4 | 0.01 | 0.01 | balance |
| 2 | 18 | 12 | 2 | 4 | 0 | 0.1 | balance |
| 3 | 18 | 12 | 2 | 4 | 0 | 0.3 | balance |
| 4 | 18 | 12 | 2 | 4 | 0.1 | 0 | balance |
| 5 | 18 | 12 | 2 | 4 | 0.3 | 0 | balance |
| 6 | 18 | 12 | 2 | 4 | 0.1 | 0.1 | balance |
| 7 | 18 | 12 | 2 | 4 | 0.3 | 0.3 | balance |
| 8 | 18 | 12 | 2 | 4 | 0.5 | 0.5 | balance |
| 9 | 18 | 12 | 4 | 0 | 0 | 0 | balance |
| 10 | 18 | 12 | 2 | 4 | 0 | 0 | balance |
| 11 | 18 | 12 | 3 | 2 | 0 | 0 | balance |

Next, the produced stainless steel is immersed in a 0.05M phosphoric acid solution at a temperature of 80° C., which is a similar operating environment of a fuel cell, and a current density thereof is measured by applying a voltage to the stainless steel in a scan speed of 0.5 mV/s. In this case, in order to construct a further similar operating environment of a fuel cell, the experiment is performed under the condition that air passes through a cathode environment and hydrogen passes through an anode environment.

In addition, the produced stainless steel is immersed in a 0.05M phosphoric acid solution at a temperature of 80° C., which is a similar operating environment of a fuel cell, and contact resistance thereof is measured. In this case, in order to construct a further similar operating environment of a fuel cell, the experiment is performed under the condition that air passes through the cathode environment and hydrogen passes through the anode environment. The contact resistance is measured by applying a constant current to the stainless while increasing pressure in units of 30N/cm².

The measurement results of the current density and the contact resistance are listed in Table 2. The evaluation of current density is as follows. Samples of which current density is equal to or less than 1.75 μA/cm² are indicated by symbol \textcircled{◯}. Samples of which current density in a range of 1.75 μA/cm² to 2.25 μA/cm² are indicated by symbol “◯”. Sample of which current density is in a range of 2.25 μA/cm² to 2.55 μA/cm² are indicated by symbol “Δ”. Samples of which current density is equal to or greater than 2.55 μA/cm² are indicated by symbol “×”. The evaluation of contact resistance is as follows. Samples of which contact resistance is equal to or less than 70 mΩcm² are indicated by symbol “\textcircled{◯}”. Samples of which contact resistance in a range of 70 mΩcm² to 90 mΩcm² are indicated by symbol “◯”. Samples of which contact resistance in a range of 90 mΩcm² to 115 mΩcm² are indicated by symbol “Δ”. Samples of which contact resistance is equal to or greater than 115 mΩcm² are indicated by symbol “×”.

TABLE 2
Measurement Results of Current Density and
Contact Resistance in Embodiment of Present
Invention and Comparative Examples

| | | | | | Corrosion | | Contact | |
|---|---|---|---|---|---|---|---|---|
| Sample | Composition (wt %) | | | | Resistance | | Resistance | |
| No. | Mo | W | Ta | La | air | hydrogen | air | hydrogen |
| 1 | 2 | 4 | 0.01 | 0.01 | ◯ | ◯ | ◯ | ◯ |
| 2 | 2 | 4 | 0 | 0.1 | ◯ | ◯ | Δ | ◯ |
| 3 | 2 | 4 | 0 | 0.3 | ⊚ | ◯ | Δ | ◯ |
| 4 | 2 | 4 | 0.1 | 0 | ◯ | ◯ | Δ | ◯ |
| 5 | 2 | 4 | 0.3 | 0 | ⊚ | ◯ | Δ | ◯ |
| 6 | 2 | 4 | 0.1 | 0.1 | ⊚ | ◯ | ◯ | ◯ |
| 7 | 2 | 4 | 0.3 | 0.3 | ⊚ | ⊚ | ⊚ | ⊚ |
| 8 | 2 | 4 | 0.5 | 0.5 | ⊚ | ⊚ | ⊚ | ⊚ |
| 9 | 4 | 0 | 0 | 0 | Δ | X | X | Δ |
| 10 | 2 | 4 | 0 | 0 | ◯ | Δ | Δ | ◯ |
| 11 | 3 | 2 | 0 | 0 | Δ | Δ | X | Δ |

The low current density denotes that the sample has high corrosion resistance in the operating environment of the fuel cell. The unit of the current density is μA/cm². The contact resistance is obtained from Equation: (contact resistance)=(V·As)/I, where I is an applied current, V is a voltage measured from a sample, and As is an area of the sample. Therefore, the unit of the measured contact resistance is mΩcm². As the contact resistance decreases, the conductivity increases.

Referring to the measurement results in the embodiment of the present invention (Sample Nos. 1 to 8) and Comparative Example (Sample Nos. 9 to 11) listed on Table 2, if the tantalum (Ta) and/or the lanthanum (La) are added to the austenitic stainless steel, the corrosion resistance is improved and the contact resistance is reduced in the operating environment of the fuel cell. Particularly, it can be seen that, if the tantalum (Ta) and lanthanum (La) having a range of 0.2 to 0.7 wt % are added to the austenite stainless steel, the corrosion resistance and conductivity are further improved.

1. A separator for a fuel cell consisted of an austenitic stainless steel that contains molybdenum (Mo), tungsten (W) and one or more of tantalum (Ta) and lanthanum (La).

2. The separator according to claim 1, wherein an amount of the tantalum (Ta) is in a range of 0.01 wt % to 1.0 wt %.

3. The separator according to claim 1, wherein an amount of the lanthanum (La) is in a range of 0.01 wt % to 1.0 wt %.

4. The separator according to claim 1, wherein an amount of the tantalum (Ta) or the lanthanum (La) is in a range of 0.2 wt % to 0.7 wt %.

5. The separator according to claim 1, wherein an amount of the molybdenum (Mo) is in a range of 0.2 wt % to 5 wt %.

6. The separator according to claim 1, wherein an amount of the tungsten (W) in a range of 0.01 wt % to 15 wt %.

7. A fuel cell having the separator according to claim 1.
